(19) United States
(12) Patent Application Publication
(10) Pub. No.: US 2011/0226147 A1
(43) Pub. Date: Sep. 22, 2011

(54) Method of producing a transparent polychromatic printed iridescent image

(75) Inventors: Francois TRANTOUL, LUNEL (FR); Eric PHILIPPE, EYGUIERES (FR); Laurence BES, MONTPELLIER (FR)

(73) Assignee: FASVER, BAILLARGUES (FR)

(21) Appl. No.: 13/049,981

(22) Filed: Mar. 17, 2011

(30) Foreign Application Priority Data
Mar. 17, 2010 (FR) 10.01060

(51) Int. Cl. B41F 33/00; B42D 15/00

(52) U.S. Cl. 101/483; 283/85

(57) ABSTRACT

A method of producing a transparent polychromatic printed iridescent image (8) of any kind in which at least two colors change simultaneously when there is a change in the viewing angle of the image under illumination by at least one visible light source.

The invention relates to a method of producing a transparent polychromatic printed iridescent image of any kind (that is to say an image which can incorporate all the various nuances of color and of form, optionally continuous color variations (graduating, faded, etc.), shadows, variations in intensity, speckled effects, etc.), in which at least two colors—especially each color—change simultaneously according to the viewing angle of said transparent image under illumination in visible light.

The invention relates also to a transparent polychromatic iridescent image of any kind so obtained, and to the use of such a transparent polychromatic iridescent image of any kind for the authentication of documents and/or of products bearing such an image under illumination in visible light.

Such a transparent polychromatic printed iridescent image of any kind can have numerous benefits and various applications, especially as a means of authentication and/or for decorative purposes.

Throughout the text:
the expression “visible light” denotes light whose spectral composition is situated in the visible spectrum, from 0.4 μm to 0.8 μm;
the expression “transparent image” denotes an image which, when it covers a document or a product, allows underlying characters or motifs of the document to be distinguished—especially read—by normal visualization (without a specific instrument), at least under illumination in visible light. It is possible that the transparent image will confer a certain opalescence on the characters and/or motifs of the document, but a transparent image does not totally conceal, at least under illumination in visible light, the underlying characters and/or motifs of the document.

Iridescent markings are often used for the purpose of authenticating a document—especially a bank-note. To that end there are used inks, called OVI® (for “optically variable inks”), which are suitable for forming iridescent motifs on the surface of a solid substrate. Such inks do not permit the formation of an iridescent motif that is polychromatic and transparent and, especially, that is suitable for application to and for extending over the surface of a printed document or of a product while allowing underlying motifs and/or printing to be read.

EP 2 020 303 describes a polychromatic image obtained by heat transfer of interference pigments, the colors of which reproduce the colors of a reference image only according to one viewing angle. Such a polychromatic image, the actual colors of which are visible only according to one viewing angle, is not transparent.

In various applications, however, the low-cost production of an iridescent and transparent image for reproduction is particularly important. That is the case in particular on official documents such as passports, identity cards, driving licenses, residence permits, vehicle registration cards, bank-notes, cheques or other payment orders, transport documents, etc. It is also the case on high-value products, especially packaging, perfumes, cosmetics, etc. Such a transparent image allows a first level of identification and/or authentication to be provided by superimposing it on underlying motifs and/or writing (for example variable writing), without requiring a specific portion of the surface for that image, that is to say without reducing the available (often limited) space for the production of underlying motifs and/or writing.

A known solution for producing a complex transparent image consists in using a transparent hologram. This solution is nevertheless very expensive and complex to implement.

EP 0 230 097 describes an optical component for the authentication of a document or of a product. Such a component has a first, metallized zone which produces a rainbow effect according to a first orientation of the component relative to an illumination direction, said rainbow effect disappearing when the component is oriented perpendicularly to the first orientation by being pivoted about a direction normal to the surface. The component also comprises a second zone which is de-metallized and coated with a dielectric material producing a colored effect having a first color for a first orientation of the component and having a second color, different from the first color, for the orientation perpendicular to the first orientation.

Such an optical component is complex, expensive and limited in terms of its application to authentication by rotation in a plane of said component placed on a document or on a product to be authenticated. It is further limited to the configuration in which an operator capable of authenticating the document or the product must be positioned in the plane containing the light source and the optical component.

EP 0 230 097 also describes a method of preparing such a component, in which there are carried out a step of stamping a layer of varnish carried by a transparent film, then a step of metallization of the stamped varnish, then a step of partial de-metallization of the stamped varnish and a step of deposition of a transparent dielectric material having a high refractive index, for example zinc sulfide.

Such a method comprises a large number of successive steps. In particular, it requires a step of vacuum metal deposition, which requires complex and cumbersome means, especially for forming and maintaining the vacuum.

Accordingly, the invention aims to remedy those disadvantages and to propose a method suitable for permitting the production of a transparent polychromatic printed iridescent image of any kind. The invention aims in particular to permit the reproduction of an original image which is polychromatic in subtractive synthesis (material-color principle), in a printed transparent and iridescent form, in which at least two colors change simultaneously according to the viewing angle under illumination by at least one visible light source, and which can incorporate very varied nuances and combinations of colors, and complex motifs.

The invention also aims to propose such an image which can be placed on a product or a document that is to be identified and/or authenticated—especially on a document of small size—on which the surface area available for the placing of motifs and/or writing, especially for identification and/or authentication purposes, is limited.

The invention aims in particular to propose such an image which permits the production of first-level identification and/or authentication motifs, that is to say motifs which can be seen normally and directly without requiring specific equipment for detecting said motifs.

The invention aims in particular to propose a method of producing identification and/or authentication motifs which can be placed on documents and/or products and which can reliably be analyzed by means of automated reading devices.

The invention also aims to produce a transparent polychromatic printed iridescent image in which only the colors change according to the viewing angle of said transparent image under illumination by at least one visible light source.

The invention also aims to achieve all those objectives at a lower cost.

The invention additionally aims to propose such a solution which preserves employees' working practices, is simple to use and the implementation of which involves only a small number of operations.

To that end, the invention relates to a method of producing a transparent polychromatic printed iridescent image of any kind in which at least two colors—especially all the colors—change simultaneously when there is a change in the viewing angle of said image under illumination by at least one visible light source, wherein:
at least two images, called printed monochromatic images, are printed separately, one after the other,
each printed monochromatic image is printed using a printing composition which comprises a proportion of a powder comprising at least one interference pigment, said powder being dispersed in a liquid printing medium, each interference pigment and said proportion are so chosen that said printed monochromatic image is transparent,
the interference pigments of each printing composition are so chosen that the printed monochromatic images are of different colors,
the different printed monochromatic images form, according to a first angular range of visualization, a polychromatic transparent image according to a first composition of colors in additive synthesis and, according to a second angular range of visualization, which is different from said first angular range of visualization, a second composition of colors in additive synthesis.

Completely unexpectedly, the inventors have observed that it is possible to print at least two superimposed printed monochromatic images with distinct interference pigments and thus obtain a polychromatic printed iridescent image of any kind which is transparent and which simultaneously changes colors according to the same variation of viewing angle under illumination by at least one visible light source. Inexplicably, there is in fact obtained a simultaneous change in the colors of the different printed monochromatic images between a first viewing angle, at which each of the printed monochromatic images appears in a first color, and a second viewing angle, which is different from the first viewing angle, at which each of the printed monochromatic images appears in a second color.

Furthermore, while interference pigments are normally used in thick and opaque paints to confer a pearly or glossy effect, the inventors have found that they can actually be used to form transparent images and yet emit particularly dense and visible nuances of color. Nevertheless, the color so imparted does not result from the material-color principle (subtractive synthesis) but, on the contrary, must be treated as additive synthesis. Also unexpectedly, it is found that the variations in color according to the viewing angle allow three primary colors to be obtained according to a first viewing angle and three different primary colors to be obtained according to a second viewing angle, so that the image is visible in perfectly polychromatic form at each viewing angle.

Advantageously and according to the invention:
there is chosen or produced an original image which is polychromatic in subtractive synthesis and visible in visible light;
there are produced and recorded at least three images, called filtered monochromatic images, by filtering of the original image according to a spectral bandwidth of less than or equal to 15 nm centred on a wavelength, called the filtering wavelength, chosen from the wavelengths of at least three primary colors, the different filtering wavelengths of the filtered monochromatic images being distinct in pairs, each of the filtering wavelengths being at least approximately equal to a wavelength of a peak of light reflected by an interference pigment, under illumination by at least one visible light source;
each printed monochromatic image is printed by reproducing one of the filtered monochromatic images and using a printing composition which comprises at least one interference pigment having a wavelength of a peak of reflected light corresponding to said filtering spectral band, especially for a viewing angle substantially normal to the image.

In particular, a color change of such a transparent image according to the invention is obtained under illumination by at least one visible light source by reorientation of said transparent image between a first position, in which the angle of visualization corresponds to a first direction of visualization at least substantially perpendicular to the plane of the transparent image, and a second position, in which the angle of visualization corresponds to a second direction of visualization which extends in a solid angle having a different predetermined value, especially from 10° to 45°, about the first direction of visualization.

Such a simultaneous color change of each of the printed monochromatic images comprising an interference pigment permits a change in the colors of said image by reorientation of said image according to a change of viewing angle having a predetermined value.

In particular, such a method according to the invention is suitable for producing an image having at least one polychromatic motif formed of a first initial color and of at least one second initial color at a first angle of visualization—especially an angle of vision substantially perpendicular to the image—and in which the first initial color changes into a first final color at a second angle of visualization distinct from the first angle of vision. In an advantageous embodiment according to the invention, the second initial color changes, simultaneously with the change in said first initial color, into a second final color at the same second angle of visualization distinct from the first angle of visualization. In a preferred embodiment according to the invention, a third initial color changes, simultaneously with the changes in the first and second initial colors, into a third final color according to the same second angle of visualization. Advantageously, the three interference pigments are chosen so that the three initial colors are three distinct, complementary primary colors capable of forming all the colors of a visible spectrum in additive synthesis, and so that the three final colors (which are visible after reorientation of the image) are also three distinct, complementary primary colors capable of forming all the colors of a visible spectrum in additive synthesis.

Advantageously, a method according to the invention is suitable for permitting the simultaneous change of a first initial color into a first final color and of a second initial color into a second final color, the first initial color being substantially identical to the second final color, and the second initial color being substantially identical to the first final color. In this particular embodiment, the two initial colors are not superimposed in the transparent polychromatic printed iridescent image.

The inventors have observed that, contrary to the teaching of the prior art, according to which interference pigments are used for their glossy effects in non-transparent pearlescent paints—especially for motor vehicles—in a proportion of from 2 to 6 wt. %, the use of interference pigments in separate layers in a method according to the invention allows a transparent polychromatic image to be obtained in which at least two colors change according to two distinct viewing angles.

Advantageously and according to the invention:
at least three filtered monochromatic images are produced and recorded, the different filtering wavelengths of the filtered monochromatic images being suitable for permitting the formation, by additive synthesis, of all the colors of the visible spectrum;
at least three printed monochromatic images are printed separately, one after the other—especially one above the other.

A transparent polychromatic printed iridescent image of any kind according to the invention is suitable for providing a first level of authentication—under illumination in visible light, and at two distinct viewing angles, the transparent polychromatic image appears according to two distinct polychromatic distributions—and a second level of authentication—it allows motifs and/or writing beneath the image to be read owing to its transparency. These two polychromatic distributions can be characterized by spectrophotometric analyses allowing the interference pigments to be identified.

Advantageously, a method according to the invention is also characterized by at least one of the following features:
in order to produce each of the filtered monochromatic images, an original of the polychromatic original image of any kind, visible in visible light, is illuminated, and the polychromatic image reflected by the illuminated original is filtered according to a spectral bandwidth of less than or equal to 15 nm centred according to the filtering wavelength of the primary color corresponding to the filtered monochromatic image; advantageously, the polychromatic reflected image is filtered with bandpass filters having a spectral bandwidth of the order of 10 nm, especially with interference bandpass filters;
there is chosen, as the filtering wavelength and the wavelength of the peaks of light reflected by the interference pigments under illumination by the visible light source (by selecting appropriate filtering means and interference pigments), for the different printed monochromatic images of a set producing a reproduction of an original image—at a viewing angle substantially perpendicular to the plane of the printed monochromatic image—at least one wavelength in the green region, at least one wavelength in the red region and at least one wavelength in the blue region; advantageously, there are chosen wavelengths suitable for being separated by the same spectral distance of from 80 nm to 100 nm, especially 90 nm; especially a wavelength in the green region of from 500 nm to 570 nm, a wavelength in the red region of from 600 nm to 680 nm, and a wavelength in the blue region of from 430 nm to 480 nm;
advantageously, each interference pigment is chosen to have a spectrum of reflected light having a band of reflected light in the blue region, in the red region or in the green region; advantageously, there is chosen a first interference pigment having a band of reflected light in the blue region for a first viewing angle—especially substantially perpendicular to the plane of the printed monochromatic image—and a band of reflected light in the yellow region for a second viewing angle—especially at substantially 25° relative to the plane of the printed monochromatic image, the second viewing angle being different from the first viewing angle; advantageously, there is chosen a second interference pigment having a band of reflected light in the red region for the same viewing angle and a band of reflected light in the green region for the second viewing angle; advantageously, there is chosen a third interference pigment having a band of reflected light in the green region for the first viewing angle and a band of reflected light in the red region for the second viewing angle;
the printed monochromatic images are printed in such a manner that, in the order in which the illuminating light is received at a viewing angle substantially perpendicular to the plane of the printed monochromatic images, they are in the order blue, red, green of the filtering wavelengths and wavelengths of the peaks of light reflected by the interference pigments;
the printed transparent monochromatic images are printed one on top of the other, with or without an intermediate layer;
for one set providing a reproduction of a polychromatic original image, only three printed monochromatic transparent images are printed, one in green, one in red and one in blue; each printed monochromatic transparent image is printed in a single print layer;
in order to produce and record each filtered monochromatic image, the filtered image is captured with photosensitive charge-coupled devices CCD, and a corresponding digitized image is recorded; a halftone image is formed from each filtered monochromatic image and is then used to print the printed monochromatic transparent image; advantageously, the halftone image has a raster of from 60 to 133, especially of the order of 80 (this value corresponding to the number of rows of dots per inch (2.54 cm);
the different printed monochromatic transparent images of one set are printed substantially according to the same print thickness; each printed monochromatic transparent image is printed so that the quantity of interference pigment in each dot is a function of the light intensity of the polychromatic original image at that dot according to the corresponding filtering wavelength (that function being proportional in the case of a positive and inversely proportional in the case of a negative); interference pigments having a purity factor (ratio of the quantity of monochromatic light reflected according to the dominant wavelength of the emission peak to the sum of that quantity of reflected monochromatic light and the quantity of reflected visible light) close to 1, quasi-monochromatic having a main peak of reflected light, or monochromatic having one and only one peak of reflected light;
each printing composition is allowed to dry and/or harden after one printed monochromatic transparent image has been printed and before another printed monochromatic transparent image is printed;
a set of printed monochromatic transparent images which are positive images of an original image, suitable for reproducing a positive of the original image in additive synthesis, is printed; advantageously, a set of printed monochromatic transparent images which are images having complementary colors of an original image is printed;
a set of printed monochromatic transparent images which are negative images of an original image, suitable for reproducing a negative of the original image in additive synthesis, is printed; advantageously, a set of printed monochromatic transparent images which are images having complementary colors of the negative images of an original image is printed;
for printing each printed monochromatic transparent image there is used a printing composition which includes an interference pigment and which, at least after drying, is transparent to visible light when it is placed under illumination in visible light;
the printed monochromatic transparent images are printed by screen printing; advantageously, there is used a printing composition formed of a non-aqueous screen printing varnish based on volatile organic solvent(s) of the type which hardens by solvent evaporation; a screen printing stencil is produced from each filtered monochromatic image, and the different screen printing stencils are produced from the same fabric; in a variant, it is possible to print the printed monochromatic transparent images by flexography, by offset, by heliography or by any other known printing process suitable for permitting the printing of logos, images or photographs without any limitation in terms of design; it is also possible to use a printing composition formed of a UV-polymerising screen printing varnish;
the successive printed monochromatic transparent images are printed on the free outside face of a film which is transparent in the visible range and comprises at least one layer formed by the continuous printing of a printing composition, for example a film as described in EP 0 271 941 or U.S. Pat. No. 5,232,527.

The invention makes it possible for the first time to obtain, at low cost, a transparent polychromatic printed iridescent image of any kind in which at least two colors change according to the same value of variation of a viewing angle under illumination in visible light.

The invention also makes it possible to obtain a transparent polychromatic printed iridescent image of any kind which, at a viewing angle substantially perpendicular to the plane of said image, is a faithful reproduction, with all the nuances of color and the forms which can vary infinitely in a continuous manner, of a polychromatic original image of any kind which is visible in visible light. The original can be a print or a stored analogue image (photographic, cinematography, video, etc.) or a digital image stored on a computer mass storage device or the like.

It is to be noted that this result is obtained not by using broad-band filtering as in the case of conventional four-color printing by subtractive synthesis, but by using selective narrow-band filtering in visible light and three-color additive synthesis under illumination in visible light.

Advantageously and according to the invention, each printed monochromatic image is printed using a printing composition in which the peak of light reflected by each interference pigment, under illumination by at least one visible light source, has a width at 80% of the height of said peak of from 10 nm to 30 nm.

Advantageously and according to the invention, each printed monochromatic image is printed using a printing composition in which the peak of light reflected by each interference pigment, under illumination by at least one visible light source, has a width at 20% of the height of said peak of from 15 nm to 40 nm.

Advantageously and according to the invention, each printed monochromatic image is printed using a printing composition in which the particles forming each interference pigment have a largest average size of from 5 μm to 40 μm—especially of the order of 20 μm.

Advantageously and according to the invention, each printed monochromatic image is printed using a printing composition in which the particles forming each interference pigment are lamellae formed of at least one metallic oxide.

Advantageously and according to the invention, each metallic oxide is chosen from the group formed of titanium oxides, aluminium oxides and tin oxides.

Advantageously and according to the invention, each printed monochromatic image is printed using a printing composition in which the proportion by weight of each interference pigment in the printing liquid is less than 25%, especially from 10% to 25%, preferably from 15% to 25%, in particular of the order of 20%.

Advantageously and according to the invention, each printed monochromatic image is printed so that the value of variation of the viewing angle at which the change in color of the transparent polychromatic printed iridescent image of any kind is visualized is less than or equal to 45°—especially from 10° to 45°, in particular of the order of 25°.

Advantageously and according to the invention there is chosen a first interference pigment whose peak of reflected light, under illumination by at least one visible light source, has, according to a first viewing angle—especially substantially perpendicular to the plane of the corresponding printed monochromatic image—a maximum intensity of reflected light whose wavelength is from 430 nm to 480 nm. Advantageously, a first interference pigment is chosen from the group formed of interference pigments which are blue in color and have a substantially monochromatic visible light reflection spectrum, that is to say which have a visible light reflection band extending over a narrow wavelength range.

Advantageously and according to the invention there is chosen a second interference pigment whose peak of reflected light, under illumination by at least one visible light source, has, according to a first viewing angle—especially substantially perpendicular to the plane of the corresponding printed monochromatic image—a maximum intensity of reflected light whose wavelength is from 600 nm to 680 nm. Advantageously, a second interference pigment is chosen from the group formed of interference pigments which are red in color and have a substantially monochromatic visible light reflection spectrum, that is to say which have a visible light reflection band extending over a narrow wavelength range.

Advantageously and according to the invention there is chosen a third interference pigment whose peak of reflected light, under illumination by at least one visible light source, has, according to a first viewing angle—especially substantially perpendicular to the plane of the corresponding printed monochromatic image—a maximum intensity of reflected light whose wavelength is from 500 nm to 570 nm. Advantageously, a third interference pigment is chosen from the group formed of interference pigments which are green in color and have a substantially monochromatic visible light reflection spectrum, that is to say which have a visible light reflection band extending over a narrow wavelength range.

In particular, interference pigments are chosen which have peaks of reflected light, under illumination by at least one visible light source, which are disjoint, that is to say which, in pairs, exhibit substantially no overlapping of their reflected light spectra, under illumination by at least one visible light source.

Advantageously and according to the invention there is printed first a printing composition containing a first interference pigment, then a printing composition containing a second interference pigment, then a printing composition containing a third interference pigment.

Advantageously there is printed first the blue interference pigment, then the red interference pigment, then the green interference pigment, the three colors blue, red and green of the first, second and third interference pigments being understood according to a viewing angle substantially normal to the plane of the printed image.

Advantageously and according to the invention, a film of an adhesive material suitable for permitting fixing of the transparent image to a substrate is deposited by printing.

The invention additionally extends to a transparent polychromatic printed iridescent image of any kind in which at least two colors—especially all the colors—of said transparent image change simultaneously when there is a change in the viewing angle of said image under illumination by at least one visible light source.

The invention extends to a printed iridescent image of any kind which is transparent and polychromatic and in which at least two colors of said printed iridescent image of any kind change simultaneously when there is a change in the viewing angle of said image under illumination by at least one visible light source.

The invention relates also to a transparent polychromatic printed iridescent image of any kind obtained by a method according to the invention, in which:
at least two colors of said transparent image change simultaneously when there is a change in the viewing angle of said image under illumination by at least one visible light source;
said transparent image comprising at least two images, called printed monochromatic images, each printed monochromatic image comprising at least one interference pigment which reflects a color under illumination by at least one visible light source.

In an image according to the invention:
the different printed monochromatic images form, according to a first angular range of visualization, a polychromatic transparent image according to a first composition of colors in additive synthesis and, according to a second angular range of visualization, which is different from said first angular range of visualization, a second composition of colors in additive synthesis of said polychromatic transparent image.

Advantageously, each printed monochromatic image of an image according to the invention corresponds to the filtering of an original image which is polychromatic in subtractive synthesis and visible in visible light, according to a spectral bandwidth of less than or equal to 15 nm centred on a wavelength, called the filtering wavelength, chosen from the lengths of at least three primary colors, the different filtering wavelengths of the filtered monochromatic images being distinct in pairs, each of the filtering wavelengths being at least approximately equal to a wavelength of a peak of light reflected by the interference pigment, under illumination by at least one visible light source, of the corresponding filtered monochromatic image.

Advantageously, an image according to the invention has at least three colors which change simultaneously when there is a change in the viewing angle under illumination by at least one visible light source.

Advantageously, an image according to the invention is also characterized by at least one of the following features:
it comprises at least one printed monochromatic transparent image having at least one reflected light peak wavelength, under illumination by at least one visible light source, in the green region for a first viewing angle and in the red region for a second viewing angle (which is distinct from the first viewing angle); at least one printed monochromatic transparent image having at least one reflected light peak wavelength, under illumination by at least one visible light source, in the red region for the first viewing angle and in the green region for the second viewing angle; and at least one printed monochromatic transparent image having at least one reflected light peak wavelength, under illumination by at least one visible light source, in the blue region for the first viewing angle and in the yellow region for the second viewing angle;
the wavelengths of the peaks of light reflected by the interference pigments, under illumination by the visible light source, of the printed monochromatic images are, for each viewing angle, separated by the same spectral distance of from 80 nm to 100 nm, especially 90 nm; advantageously it comprises, for each viewing angle, a printed monochromatic image having a wavelength in the green region of from 500 nm to 570 nm, a printed monochromatic image having a wavelength in the red region of from 600 nm to 680 nm, and a printed monochromatic image having a wavelength in the blue region of from 430 nm to 480 nm;
the printed monochromatic images of one set follow one another in the order in which the light is received for the first viewing angle in the order blue, red, green of the wavelengths of the peaks of reflected light;
advantageously, the printed monochromatic images are stacked one on top of another without an intermediate layer; the printed monochromatic images have at least substantially the same print thickness;
each printed monochromatic image is formed of a printing composition which is transparent at least to visible light;
it comprises a first set of positive printed monochromatic images which comprise pigments that are interferential under illumination in visible light, and which are suitable for reproducing, in additive synthesis, a positive of a polychromatic original image, and a second set of negative printed monochromatic images which comprise pigments that are interferential under illumination in visible light, and which are suitable for reproducing, in additive synthesis, a negative of a polychromatic original image; these two sets can be superimposed and are reproductions of the same polychromatic original image, one in negative, the other in positive; in a variant, they are reproductions of two different original images.

The invention extends also to the use of an image according to the invention. The invention extends in particular to the use of an image according to the invention for marking for the purpose of identifying and/or authenticating products and documents, in particular official documents—especially passports, identity cards, driving licenses, vehicle registration cards or the like, fiduciary documents such as bank-notes, cheques, credit cards or other payment orders, transport documents, entry tickets, cards granting entitlement to various benefits, etc.

The invention extends also to a product or to a document comprising at least one image according to the invention.

The invention relates also to such a method of producing a transparent polychromatic printed iridescent image of any kind, to such a transparent polychromatic printed iridescent image, and to such a product or such an official document bearing at least one such image, characterized in combination by all or some of the features mentioned hereinabove or hereinbelow.

Other objects, features and advantages of the invention will become apparent upon reading the following description, which refers to the accompanying figures showing preferred embodiments of the invention, which are given solely by way of non-limiting examples, and in which:

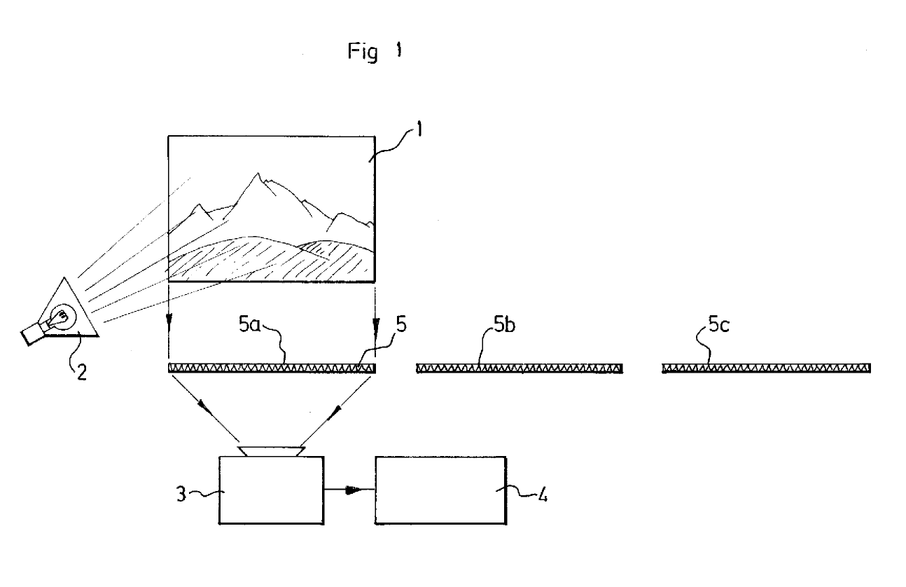

FIG. 1 is a diagrammatic representation showing an installation which allows a step of a method according to the invention to be carried out,

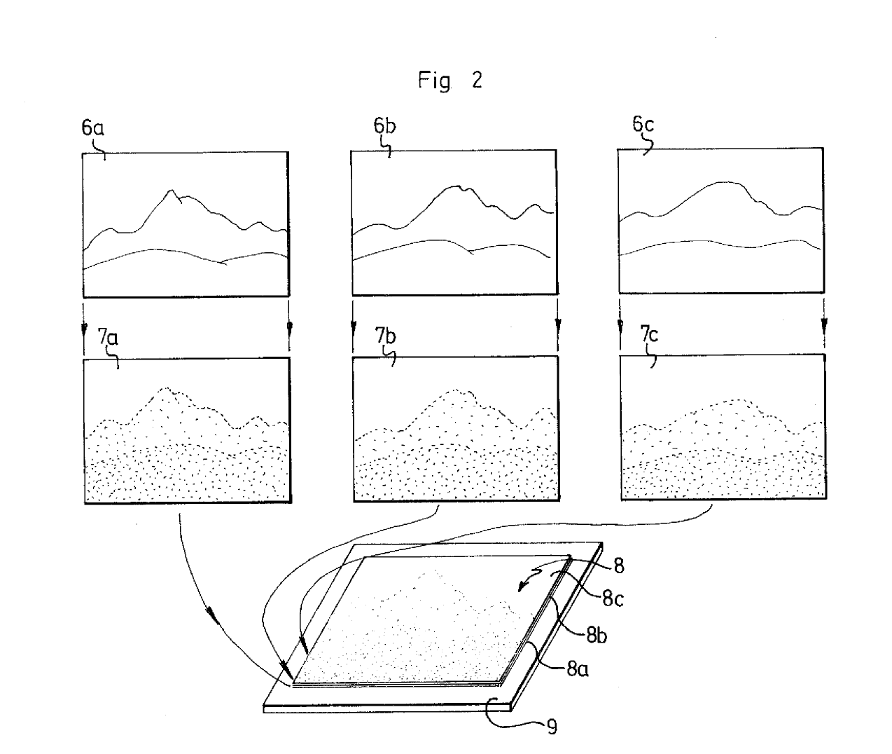

FIG. 2 is a diagram showing various steps of a method according to the invention,

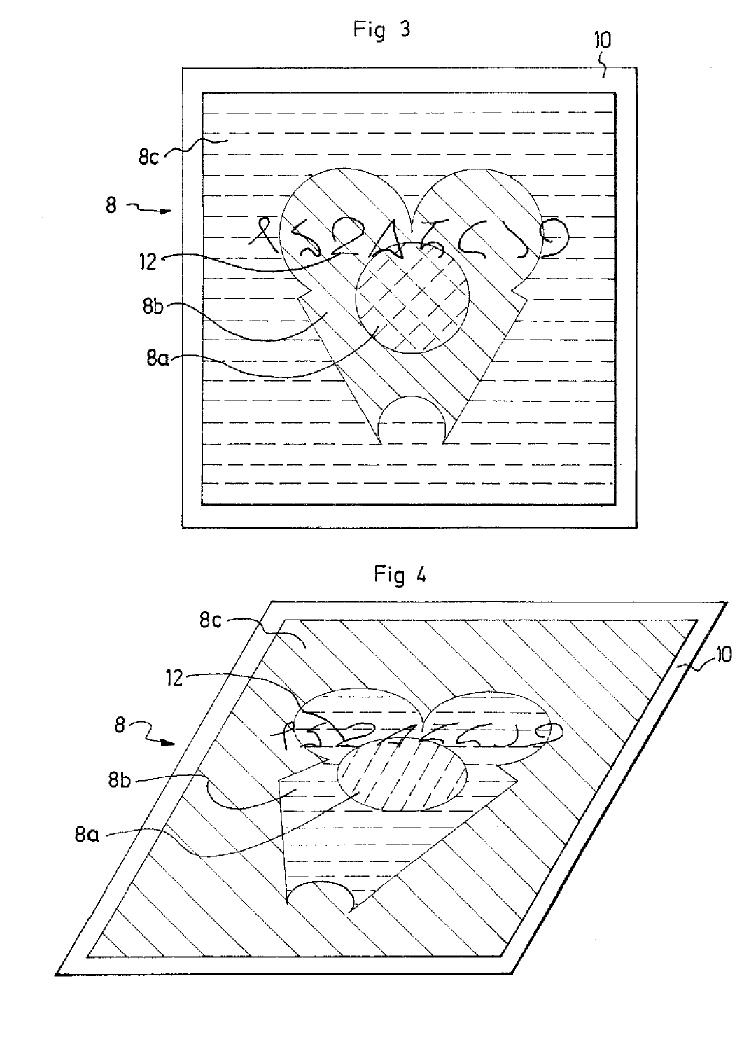

FIG. 3 is a diagram showing an example of a document protected by a transparent image according to the invention.

An installation for carrying out a method according to the invention shown in FIG. 1 comprises a polychromatic original image 1 colored according to the material-color principle (subtractive synthesis), visible in visible light, such as a photograph or an image printed by conventional four-color printing, which is to be reproduced with all the nuances of color and of form in order to obtain a transparent polychromatic printed iridescent image 8 of any kind in which each color changes simultaneously according to the same variation in the viewing angle under illumination by at least one visible light source. An original of the polychromatic original image 1 is illuminated by a visible light source 2 such as daylight or an incandescent lamp. The light illuminating the polychromatic original image 1 is a visible white light which is reflected by the original image 1 in the direction towards a CCD camera 3, which is connected to a microcomputer 4 allowing the images captured by the camera 3 to be stored. A bandpass filter 5 is interposed in the optical path of the reflected light. The filter 5 is chosen from at least three interference bandpass filters 5a, 5b, 5c whose spectral bandwidth is less than 15 nm—especially of the order of 10 nm—and whose filtering wavelength is chosen to be at least approximately equal to the wavelength of a peak of light reflected by an interference pigment under illumination in visible light, that pigment additionally being suitable for permitting the subsequent printing of an image, that is to say for being compatible with the printing means and techniques that are used, as described hereinbelow. The filtering wavelengths are chosen from the wavelengths of at least three primary colors which are able to form all the colors of the visible spectrum by additive synthesis. In particular, three wavelengths are sufficient, provided that each primary color cannot be balanced out by the other two. It is also possible to use more than three wavelengths.

The image obtained from the filter 5 is a filtered monochromatic high-contrast image. The camera 3 is, therefore, a monochrome camera. Three filtered monochromatic images 6a, 6b, 6c are produced from the same polychromatic original image 1 with each of the three monochromatic filters 5a, 5b, 5c, respectively. The three filtered monochromatic images 6a, 6b, 6c are images which are digitized and stored in the computer 4. Each filtered monochromatic image 6a, 6b, 6c captured and digitized by the CCD camera 3 is recorded by the computer 4.

In a variant which is not shown, the polychromatic original image can be a recorded digitized image, and digital filtering means are used to produce, by software calculation, each filtered monochromatic image 6a, 6b, 6c. It is also possible to use the digital filtering of a scanner having a transfer function suitable for the filtering wavelengths.

There are then produced, as shown in FIG. 2, from the three filtered monochromatic images 6a, 6b, 6c, three print rasters 7a, 7b, 7c plotted in the manner conventional in the field of screen printing, using, for example, a raster of from 60 to 133—especially of the order of 80. The fineness of the raster is adapted according to the viscosity of the printing composition and its solids content in a manner known per se in the field of screen printing.

The print rasters 7a, 7b, 7c are each formed of a film bearing a high-contrast image whose raster dot density at each dot of the image corresponds to the light intensity of the polychromatic image 1 that is to be reproduced.

In the case where a positive reproduction of the polychromatic original image 1 is to be produced, the raster dot density at each dot of the high-contrast image in the print raster that is negative corresponds to the luminous flux of the polychromatic original image 1 reflected by the interference pigment at that dot, according to each filtering wavelength. In that case, therefore, it is necessary to carry out an inversion of the filtered monochromatic images 6a, 6b, 6c, which are positives, in order to obtain negative screen printing rasters 7a, 7b, 7c. The inversion can be carried out either by image capturing software by the CCD camera 3 or with the aid of conventional image processing software starting from the digitized and recorded images, or by the processing software of the plotter permitting production of the print rasters.

In the opposite case, in which a negative reproduction of the polychromatic original image 1 is to be produced, inversion of the filtered monochromatic images 6a, 6b, 6c is not carried out, and the screen printing rasters 7a, 7b, 7c are positives.

The screen printing rasters 7a, 7b, 7c are produced on transparent films, allowing the subsequent production, for example by exposure of a photopolymer, of screen printing stencils, one for each filtered monochromatic image 6a, 6b, 6c.

Each screen printing stencil is produced, by way of non-limiting example, from a fabric whose mesh comprises from 120 to 165 threads/cm, the threads having a diameter of from 27 μm to 34 μm. A layer of photopolymeric material having a thickness of 18 μm is used.

Each screen printing stencil accordingly represents, for each filtering wavelength, a luminous flux reflected by the polychromatic original image 1 in the filtering wavelength corresponding to the filter used, or the inverse of that luminous flux.

There are then printed, separately, one after the other, and one above the other (with or, preferably, without the interposition of a transparent intermediate layer), on a transparent print substrate 9, three printed monochromatic images, called images 8a, 8b, 8c, of the same format corresponding to the format of the polychromatic printed iridescent image 8 of any kind that is to be formed. The transparent print substrate 9 can be of any kind, provided that it is compatible with the printing technique used. For each printed monochromatic image 8a, 8b, 8c there is used the screen printing stencil produced from one of the filtered monochromatic images 6a, 6b, 6c and a transparent printing composition comprising an interference pigment whose wavelength of the reflected light peak, under illumination 2 in visible light, is equal to the filtering wavelength used to obtain said filtered monochromatic image 6a, 6b, 6c. By using in succession the three screen printing stencils corresponding to the three filtered monochromatic images 6a, 6b, 6c, the three printed monochromatic images 8a, 8b, 8c are printed in succession.

There are advantageously used as the interference pigment mineral pigments—especially chosen from the metallic oxides—which are highly suitable for printing by screen printing and are resistant to the radiation of a non-visible light source used for the employment of authentication devices (in particular, as described in WO 0024587) and which are stable over time.

As the monochromatic filter 5 there can be used, for example, interference bandpass filters marketed by LOT ORIEL (Courtaboeuf, France) as mentioned in Table 1 below.

TABLE 1

| Filter | Filtering wavelength | Color |
|---|---|---|
| 440 FS 10-50 | 440 nm | Blue |
| 460 FS 10-50 | 460 nm | Blue |
| 480 FS 10-50 | 480 nm | Blue |
| 510 FS 10-50 | 510 nm | Green |
| 530 FS 10-50 | 530 nm | Green |
| 550 FS 10-50 | 550 nm | Green |
| 620 FS 10-50 | 620 nm | Red |
| 660 FS 10-50 | 660 nm | Red |

Each time a printed monochromatic image 8a, 8b, 8c is printed, the chosen interference pigment is incorporated into a liquid printing medium formed of a screen printing varnish chosen for its ability to be transparent when it is dry and illuminated by at least one visible light source. In that manner, the light of the visible light source will be able to reach and be reflected by the interference pigments contained in the printed screen printing varnish so as to be visible from the outside, without unbalancing the colors.

The printed monochromatic images 8a, 8b, 8c are transparent in visible light, so that the polychromatic printed iridescent image 8 of any kind is itself transparent to visible light and allows any underlying lettering 12 previously applied to the transparent print substrate 9 to be seen, owing to its transparency.

The three images 8a, 8b, 8c are printed on the transparent print substrate 9 preferably starting with printed image 8a, the interference pigment of which reflects, according to a first angle of visualization substantially perpendicular to the plane of each image 8a, 8b, 8c and to the plane of the print substrate 9, and under illumination in visible light, in the blue region (wavelength from 440 to 480 nm in the table above), then by printing image 8b, the interference pigment of which reflects, according to the same viewing angle, and under illumination in visible light, in the red region (wavelength from 620 to 660 nm in the table above), and finishing with printed image 8c, the interference pigment of which reflects, according to the same viewing angle, and under illumination in visible light, in the green region (wavelength from 500 to 550 nm in the table above).

Accordingly, the different printed monochromatic images 8a, 8b, 8c, according to the same viewing angle, are in the order 8a, blue, 8b, red and 8c, green, of the wavelengths of reflection, under illumination by at least one visible light source, of the blue, red and green interference pigments.

By reorientation of the polychromatic image 8 as described above according to a second angle of visualization forming, with the first angle of visualization, an angle having a value of from 10° to 45°, the same polychromatic image 8 is obtained in which:
printed image 8a appears, under illumination in visible light, in a yellow color according to this viewing angle, and
printed image 8b appears, under illumination in visible light, in a green color according to this viewing angle, and
printed image 8c appears, under illumination in visible light, in a red color according to this viewing angle.

The different printed monochromatic images 8a, 8b, 8c are printed in succession, either directly one on top of another, while observing a drying time between each layer, or by optionally interposing continuous transparent layers between them. Such a transparent layer is, for example, a layer of two-component polymerisable printing composition containing a hydroxylated polyol and an isothiocyanate or a poly-isothiocyanate in order to cause the in situ polymerisation of the mixture, yielding a thin transparent film of polyurethane, as described, for example, in EP 0 271 941 or U.S. Pat. No. 5,232,527.

All three printed monochromatic images 8a, 8b, 8c are printed using the same printing tools (the screen printing stencils used being produced from the same fabrics and with the same photopolymeric material). In particular, the printed monochromatic images 8a, 8b, 8c are printed with the same print thickness. That thickness is advantageously from 3 μm to 12 μm according to the characteristics of the screen printing stencil used. Of course, the actual thickness of the printed monochromatic image 8a, 8b, 8c at each dot depends on the motif of the image, as is always the case in screen printing. Accordingly, for each positive printed monochromatic image 8a, 8b, 8c, the quantity of interference pigment at each dot is a function of the intensity reflected, under illumination in visible light, by the polychromatic original image 1 at that dot according to the corresponding filtering wavelength.

The screen printing varnish used, incorporating the interference pigment, is chosen so that it is not capable of emitting, by photoluminescence of the screen printing varnish, light under illumination in visible light and is not capable of unbalancing the colors of the transparent polychromatic printed iridescent image 8 of any kind.

The screen printing varnish used is advantageously a non-aqueous varnish based on volatile organic solvent(s) of the type which hardens by solvent evaporation. Such solvent(s) contained in such a screen printing varnish evaporate(s) during drying and permit(s) good adhesion of the pigments to the lower layer on which the printing composition is printed. In a variant, the screen printing varnish used can be a varnish whose polymerisation is induced by ultraviolet illumination.

There is then applied, by printing, a surface layer formed of an adhesive material suitable for permitting fixing of the transparent image 8 to a document that is to be identified and/or authenticated. After fixing of the transparent image 8 to the surface of the document 10, the outside surface layer of the transparent image 8 is formed of the transparent substrate 9. The monochromatic images 8a, 8b, 8c extend in succession from the outside surface accessible under illumination by at least one visible light source in the direction of the document 10 in the order blue, red and green.

There has been described above the production of a transparent polychromatic printed iridescent image 8 of any kind in which each color changes according to the same value of variation of a viewing angle under illumination in visible light, which image is formed by three printed monochromatic images 8a, 8b, 8c.

A transparent polychromatic printed iridescent image 8 of any kind is shown in FIG. 3 according to a first viewing angle substantially perpendicular to the plane of said transparent image 8. Such a transparent image 8 has an underlying document 10 which is to be identified and/or authenticated, on which there extend in visible manner, by way of non-limiting example, lettering 12—especially written characters 12. In the front view shown in FIG. 3, the three superposed printed monochromatic images 8a, 8b, 8c do not appear. In this configuration, in which the angle of vision is substantially perpendicular to the plane of the document 10 and of the superposed printed monochromatic images 8a, 8b, 8c:
a third printed monochromatic image 8c, comprising a third interference pigment, extends at the surface of and in contact with the document 10 and has a green color (indicated diagrammatically by horizontal dashes);
a second printed monochromatic image 8b, comprising a second interference pigment, extends at the surface of and in contact with the third printed monochromatic image 8c and has a red color (indicated diagrammatically by oblique lines); and
a first printed monochromatic image 8a, comprising a first interference pigment, extends over the free accessible face of the transparent polychromatic image 8 affixed to the document 10 and has a blue color (indicated diagrammatically by a grid of oblique dashes). The transparent print substrate 9 extends at the surface of the first printed monochromatic blue image 8a.

In this configuration, the first printed monochromatic image 8a comprising the first, blue interference pigment extends beneath the print substrate 9, close to the surface of the transparent polychromatic image 8, covering the second printed monochromatic image 8b comprising the second, red interference pigment, said second printed monochromatic image 8b covering the third printed monochromatic image 8c comprising the first, green interference pigment.

It is to be noted that, in the example of the transparent polychromatic image 8 shown in FIG. 3, the interference pigments of the three printed monochromatic images 8a, 8b, 8c are not superimposed and do not generate, by additive synthesis, new colors distinct from the colors of the three blue, red and green interference pigments. However, such a superimposition is, of course, possible and makes it possible to obtain all the colors of the visible spectrum by additive synthesis by superimposing larger or smaller portions of the three monochromatic images 8a, 8b, 8c.

The same transparent polychromatic printed iridescent image 8 of any kind is shown in FIG. 4 according to a first viewing angle oriented at 25° relative to the plane of said transparent image 8 shown in FIG. 3. Such a transparent image 8 has the same underlying document 10 as shown in FIG. 3, on which there extends, in visible manner, by way of non-limiting example, lettering 12—especially written characters 12. In this configuration, in which the viewing angle is substantially at 25° relative to the plane of the document 10 and of the superposed printed monochromatic images 8a, 8b, 8c:
the third printed monochromatic image 8c, comprising the third interference pigment, extends at the surface of and in contact with the document 10 and has a red color (indicated diagrammatically by oblique lines);
the second printed monochromatic image 8b, comprising the second interference pigment, extends at the surface of and in contact with the third printed monochromatic image 8c and has a green color (indicated diagrammatically by horizontal dashes); and
the first printed monochromatic image 8a, comprising a first interference pigment, extends beneath the transparent print substrate 9, close to the accessible free face of the transparent polychromatic image 8 affixed to the document 10, and has a yellow color (indicated diagrammatically by oblique dashes).

In this configuration, the first printed monochromatic image 8a comprising the first interference pigment of yellow color extends at the surface of the transparent polychromatic image 8, covering the second printed monochromatic image 8b comprising the second interference pigment of green color, said second printed monochromatic image 8b covering the third printed monochromatic image 8c comprising the first interference pigment of red color in this viewing angle, said third printed monochromatic image 8c being applied at the surface of the document 10 to be identified and/or authenticated.

In this configuration, the change in the viewing angle of said transparent image 8 leads to the colors red and green being interchanged and the color blue being shifted to yellow and the color yellow to blue.

### Example 1

There is produced a transparent polychromatic printed iridescent image of any kind in which each color changes when there is a change in the viewing angle of said image under illumination by at least one visible light source. Such an image is formed in which a red color and a green color are interchanged when said image is reoriented at 25°. Two filtered monochromatic images are printed in succession by screen printing on a transparent print substrate 9 formed of a film of the Fasprotek®, Fasfilm® or Transfilm® type (FASVER, Baillargues, France). Each screen printing stencil is produced from a fabric whose mesh comprises 120 threads/cm, the threads having a diameter of 34 μm. A first printing composition comprising 20 wt. % of a powder formed of particles of a red interference pigment (Xirallic®, T60-21 SW, Solaris Red, Merck, Darmstadt, Germany), dispersed in a liquid printing medium (Solubilis, Tiflex, Poncin, France), is prepared. A second printing composition comprising 20 wt. % of a powder formed of particles of a green interference pigment (Xirallic®, T60-24 SW, Stellar green, Merck, Darmstadt, Germany), dispersed in a liquid printing medium (Solubilis, Tiflex, Poncin, France), is prepared in parallel. The first composition is deposited using and reproducing a first filtered monochromatic image, so as to form a first printed monochromatic transparent image. The second printing composition is then deposited on top of said first printed monochromatic transparent image, using and reproducing a second filtered monochromatic image, so as to form a second printed monochromatic transparent image superimposed on the first filtered monochromatic image and suitable for forming with the first filtered monochromatic image suitable for forming by additive synthesis all the colors of an original image. There is then printed a layer of an adhesive suitable for permitting the fixing of the transparent polychromatic printed iridescent image of any kind in which each color changes when there is a change in a viewing angle of said image under illumination by at least one visible light source to a document.

### Example 2

Printing is carried out by screen printing as described in Example 1. A first printing composition comprising 20 wt. % of a powder formed of particles of a yellow interference pigment (Xirallic®, T60-20 SW, Sunbeam gold, Merck, Darmstadt, Germany), dispersed in a liquid printing medium (Solubilis, Tiflex, Poncin, France), is prepared. A second printing composition comprising 20 wt. % of a powder formed of particles of a blue interference pigment (Xirallic®, T60-23 SW, Galaxy blue, Merck, Darmstadt, Germany), dispersed in a liquid printing medium (Solubilis, Tiflex, Poncin, France), is produced in parallel.

### Example 3

There is produced a transparent polychromatic printed iridescent image of any kind in which each color changes when there is a change in a viewing angle of said image under illumination by at least one visible light source. Such a polychromatic transparent image is formed in which a red color and a green color are interchanged while a blue color changes to a yellow color when said image is reoriented at 25°. Starting from a polychromatic image obtained by subtractive synthesis, three filtered monochromatic images obtained by filtering the original image are recorded and stored in a computer memory. Such filtered monochromatic images are obtained by means of a narrow bandpass filter—especially of the order of 15 nm—so as to obtain three filtered monochromatic images corresponding to the blue, red and green tones of the original image. The three filtered monochromatic images are printed in succession by screen printing on a transparent print substrate formed of a film of the Fasprotek®, Fasfilm® or Transfilm® type (FASVER, Baillargues, France). Each screen printing stencil is produced from a fabric whose mesh comprises 120 threads/cm, the threads having a diameter of 34 μm. A first printing composition comprising 20 wt. % of a powder formed of particles of a blue interference pigment (Xirallic®, T60-23 SW, Galaxy blue, Merck, Darmstadt, Germany), dispersed in a liquid printing medium (Solubilis, Tiflex, Poncin, France), is prepared. A second printing composition comprising 20 wt. % of a powder formed of particles of a red interference pigment (Xirallic®, T60-21 SW, Solaris Red, Merck, Darmstadt, Germany), dispersed in the same liquid printing medium (Solubilis, Tiflex, Poncin, France), is prepared. A third printing composition comprising 20 wt. % of a powder formed of particles of a green interference pigment (Xirallic®, T60-24 SW, Stellar green, Merck, Darmstadt, Germany), dispersed in a liquid printing medium (Solubilis, Tiflex, Poncin, France), is also prepared. The first, blue printing composition is deposited using and reproducing the filtered monochromatic image (obtained with the filter in the blue region) so as to form a first printed monochromatic (blue) transparent image. Then the second, red printing composition is deposited on top of said first, blue printed monochromatic transparent image using and reproducing the filtered monochromatic image (obtained with the filter in the blue region) so as to form a second printed monochromatic (red) transparent image superimposed on the first filtered monochromatic (blue) transparent image. The third, green printing composition is then deposited on top of the second, red printed monochromatic transparent image using and reproducing the filtered monochromatic image (obtained with the filter in the green region) so as to form a third printed monochromatic (green) transparent image superimposed on the second filtered monochromatic (red) transparent image.

Such a superimposition of the three blue, red, green filtered monochromatic transparent images is suitable for forming, by additive synthesis, all the colors of an original image. There is then printed a layer of an adhesive suitable for permitting the fixing of the transparent polychromatic printed iridescent image of any kind in which each color changes when there is a change in a viewing angle of said image under illumination by at least one visible light source to a document.

The invention can be the subject of very many variants. In particular, it is possible to add other types of pigments in addition to the interference pigments.

1. A method of producing a transparent polychromatic printed iridescent image (8) of any kind in which at least two colors change simultaneously when there is a change in the viewing angle of said image under illumination by at least one visible light source, wherein:
at least two images, called printed monochromatic images, are printed separately, one after the other,
each printed monochromatic image is printed using a printing composition which comprises a proportion of a powder comprising at least one interference pigment, said powder being dispersed in a liquid printing medium, each interference pigment and said proportion are so chosen that said printed monochromatic image is transparent,
the interference pigments of each printing composition are so chosen that the printed monochromatic images are of different colors,
the different printed monochromatic images form, according to a first angular range of visualization, a polychromatic transparent image according to a first composition of colors in additive synthesis and, according to a second angular range of visualization, which is different from said first angular range of visualization, a second composition of colors in additive synthesis.

2. The method as claimed in claim 1, wherein:
there is chosen or produced an original image (1) which is polychromatic in subtractive synthesis and visible in visible light;
there are produced and recorded at least three images, called filtered monochromatic images (6a, 6b, 6c), by filtering of the original image (1) according to a spectral bandwidth of less than or equal to 15 nm centred on a wavelength, called the filtering wavelength, chosen from the wavelengths of at least three primary colors, the different filtering wavelengths of the filtered monochromatic images (6a, 6b, 6c) being distinct in pairs, each of the filtering wavelengths being at least approximately equal to a wavelength of a peak of light reflected by an interference pigment, under illumination by at least one visible light source;
each printed monochromatic image (8a, 8b, 8c) is printed by reproducing one of the filtered monochromatic images (6a, 6b, 6c) and using a printing composition which comprises at least one interference pigment having a wavelength of a peak of reflected light corresponding to said filtering spectral band.

3. The method as claimed in claim 1, wherein:
at least three filtered monochromatic images (6a, 6b, 6c) are produced and recorded, the different filtering wavelengths of the filtered monochromatic images (6a, 6b, 6c) being suitable for permitting the formation, by additive synthesis, of all the colors of the visible spectrum;
at least three printed monochromatic images (8a, 8b, 8c) are printed separately, one after the other.

4. The method as claimed in claim 1, wherein there is used a printing composition in which the peak of light reflected by each interference pigment, under illumination by at least one visible light source, has a width at 80% of the height of said peak of from 10 nm to 30 nm.

5. The method as claimed in claim 1, wherein there is used a printing composition in which the peak of light reflected by each interference pigment, under illumination by at least one visible light source, has a width at 20% of the height of said peak of from 15 nm to 40 nm.

6. The method as claimed in claim 1, wherein there is used a printing composition in which each interference pigment is formed of particles having a largest average size of from 5 μm to 40 μm.

7. The method as claimed in claim 1, wherein there is used a printing composition in which the particles forming each interference pigment are lamellae formed of at least one metallic oxide.

8. The method as claimed in claim 7, wherein there is used a printing composition in which each metallic oxide is chosen from the group formed of titanium oxides, aluminium oxides and tin oxides.

9. The method as claimed in claim 1, wherein there is used a printing composition in which the proportion by weight of each interference pigment is greater than 10%.

10. The method as claimed in claim 1, wherein the proportion by weight of each interference pigment in the liquid printing medium is less than 25%.

11. A printed iridescent image of any kind which is transparent and polychromatic and wherein at least two colors of said printed iridescent image of any kind change simultaneously when there is a change in the viewing angle of said image under illumination by at least one visible light source.

12. A transparent polychromatic printed iridescent image of any kind obtained by a method as claimed in claim 1, wherein:
at least two colors of said transparent polychromatic printed image (8) change simultaneously when there is a change in the viewing angle of said image under illumination by at least one visible light source;
said transparent image (8) comprising at least one set of at least two images, called printed monochromatic images (8a, 8b, 8c), each printed monochromatic image (8a, 8b, 8c) comprising at least one interference pigment which reflects a color under illumination by at least one visible light source.

13. The image as claimed in claim 11, wherein it has at least three colors which change simultaneously when there is a change in the viewing angle under illumination by at least one visible light source.

14. The image as claimed in claim 11, wherein it comprises at least one printed monochromatic transparent image (8a, 8b, 8c) having at least one reflected light peak wavelength, under illumination by at least one visible light source, in the green region for a first viewing angle and in the red region for a second viewing angle, which is distinct from the first viewing angle; at least one printed monochromatic transparent image (8a, 8b, 8c) having at least one reflected light peak wavelength, under illumination by at least one visible light source, in the red region for the first viewing angle and in the green region for the second viewing angle; and at least one printed monochromatic transparent image (8a, 8b, 8c) having at least one reflected light peak wavelength, under illumination by at least one visible light source, in the blue region for the first viewing angle and in the yellow region for the second viewing angle.

15. A method of identifying and/or authenticating a product or document selected from the group consisting of a passport, an identity card, a driving license, a vehicle registration card, a bank-note, a cheque, a credit card or other payment order, a transport document, an entry ticket, and a card granting entitlement to various benefits, which comprises:
producing a transparent polychromatic printed iridescent image in accordance with claim 1; and
placing the image on the product or document.

16. The method as claimed in claim 2, wherein:
at least three filtered monochromatic images (6a, 6b, 6c) are produced and recorded, the different filtering wavelengths of the filtered monochromatic images (6a, 6b, 6c) being suitable for permitting the formation, by additive synthesis, of all the colors of the visible spectrum;
at least three printed monochromatic images (8a, 8b, 8c) are printed separately, one after the other.

17. The image as claimed in claim 12, wherein it has at least three colors which change simultaneously when there is a change in the viewing angle under illumination by at least one visible light source.
